(19) United States
(12) Patent Application Publication
(10) Pub. No.: US 2023/0301416 A1
(43) Pub. Date: Sep. 28, 2023

(54) DRYING DEVICE

(71) Applicant: CASIO COMPUTER CO., LTD., Tokyo (JP)

(72) Inventors: Fumihiro OSAKABE, Akishima-shi (JP); Eiichi HARADA, Hamura-shi (JP)

(21) Appl. No.: 18/124,886

(22) Filed: Mar. 22, 2023

(30) Foreign Application Priority Data
Mar. 24, 2022 (JP) 2022-047793

(51) Int. Cl. A45D 29/00; F26B 21/00

(52) U.S. Cl. CPC A45D 29/00; F26B 21/004

(57) ABSTRACT

Disclosed is a drying device including: a fan which blows a wind from an upper direction toward a surface of a nail that is a drying target; a placing stand which is disposed below the fan and includes a slit that allows the wind from the fan to pass through, and on which the nail is placed; and a raiser that is formed below the placing stand and includes an exhaust space to which the wind passing through the slit escapes.

### REFERENCE TO RELATED APPLICATIONS

This application is based upon and claims the benefit of priority from the prior Japanese Patent Application No. 2022-047793, filed on Mar. 24, 2022, the entire contents of which including description, claims, and drawings is incorporated herein by reference in its entirety.

### TECHNICAL FIELD

The present disclosure relates to a drying device.

### DESCRIPTION OF RELATED ART

When applying manicure to fingernails, for example, it is necessary to dry the manicure liquid after applying it to the fingernails.

Conventionally, printing devices are known to print on human nails and the like. Even when using such a printing device to apply nail prints by printing, it is necessary to dry the liquid agent such as the ink after printing.

In this regard, for example, JP 2000-287744 A describes the configuration of an automatic manicure applier equipped with a manicure liquid applying means for spraying manicure liquid and a manicure liquid drying means for drying the applied manicure liquid.

### SUMMARY OF THE INVENTION

According to an aspect of the present disclosure, a drying device includes: a fan which blows a wind from an upper direction toward a surface of a nail that is a drying target; a placing stand which is disposed below the fan and includes a slit that allows the wind from the fan to pass through, and on which the nail is placed; and a raiser that is formed below the placing stand and includes an exhaust space to which the wind passing through the slit escapes.

### BRIEF DESCRIPTION OF DRAWINGS

The accompanying drawings are not intended as a definition of the limits of the disclosure but illustrate embodiments of the disclosure, and together with the general description given above and the detailed description of the embodiments given below, serve to explain the principles of the disclosure, wherein:

FIG. 1 is a main part diagram showing the outer configuration of a printing device that includes a drying device according to an embodiment;

FIG. 2 is a main part diagram schematically showing a state in which both hands are set in the drying device according to the embodiment;

FIG. 3 is a plan view showing a positional relationship between a fan of the drying device and the hand placed on a placing stand;

FIG. 4 is a plan view of the placing stand in the embodiment;

FIG. 5 is a schematic side view of the drying device according to the embodiment;

FIG. 6 is a schematic plan view showing a state in which nails are placed on the placing stand of the drying device according to the embodiment;

FIG. 7 is a schematic side view of a conventional drying device;

FIG. 8 is a schematic plan view showing a state in which nails are placed on a placing stand of the conventional drying device;

FIG. 9 is a main part block diagram showing a control configuration of the printing device including the drying device according to the embodiment; and

FIG. 10 is a diagram showing the main part configuration of a modification example of the drying device.

### DETAILED DESCRIPTION

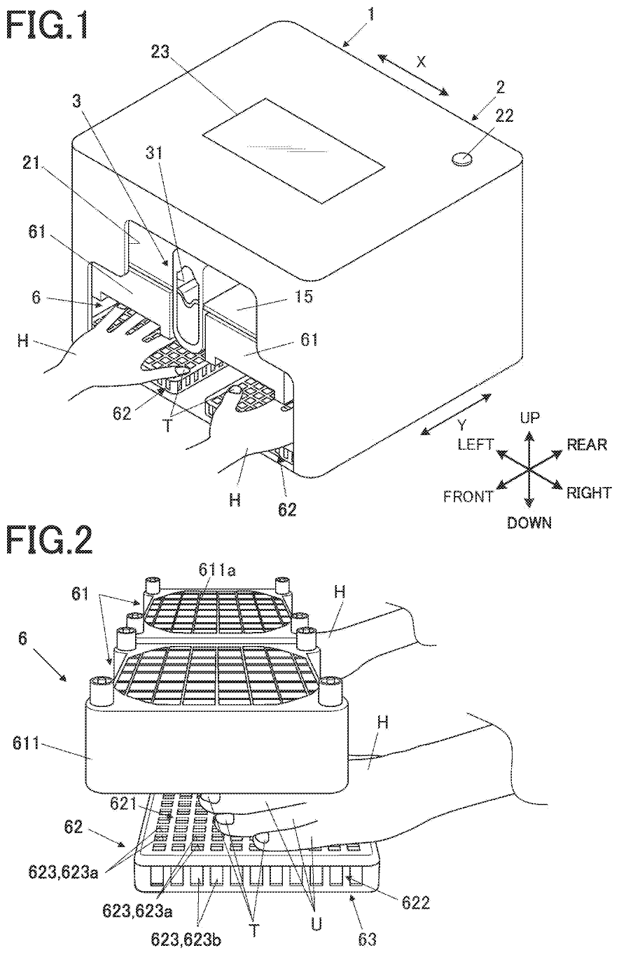

An embodiment of a drying device and a printing device including the drying device according to the present disclosure will be described with reference to FIGS. 1 to 9.

The embodiment described below is provided with various limitations technically preferable for carrying out the present disclosure. However, the scope of the present disclosure is not limited to the embodiment below or illustrated examples.

The printing device in the embodiment includes a printing mechanism that performs printing on fingernails which are printing targets and a drying device that dries the nails after printing, as described below.

Though the embodiment below describes, as an example, a printing device that prints on fingernails of hands as the printing targets, the printing targets of the printing device in the present disclosure are not limited to the fingernails of the hands. For example, toenails may be the printing targets.

FIG. 1 is a diagram showing the main part outer configuration of the printing device in the embodiment.

In the following embodiment, the up, down, left, right, front and rear indicate the directions shown in FIG. 1. Furthermore, the X direction and the Y direction indicate the directions shown in FIG. 1.

As shown in FIG. 1, the printing device 1 includes a housing 2 as a case that is formed in a nearly box shape.

An opening 21 is formed on the front surface side (front surface side of the printing device 1, front side in FIG. 1) of the housing 2.

In the embodiment, the inside of the housing 2 is divided into upper and lower sections by a dividing plate 15 as described below. The lower section of the dividing plate 15 is a space for drying where the left and right hands H can be placed side by side as described below (see FIG. 1). Thus, at least the portion of the opening 21 that is lower than the dividing plate 15 (portion closer to the bottom of the device) is wide enough to cover almost the entire left-right direction of the device (lateral direction of the printing device 1, left-right direction, X direction in FIG. 1) so that the left and right hands H can be inserted into the device in the side-by-side position.

An operation unit 22 of the printing device 1 is provided on the upper surface (top plate) of the housing 2. The operation unit 22 is an operation button such as a power switch button to turn on/off the printing device 1, for example. When the operation unit 22 is operated, the operation signal according to the operation is output to a control device 10. The control device 10 performs control according to the operation signal, and operates each component of the printing device 1. For example, in the case where the operation unit 22 is a power switch button, the printing device 1 is turned on/off according to the button operation.

A display 23 is provided on the upper surface (top plate) of the housing 2.

The display 23 consists of, for example, a liquid crystal display (LCD), organic electroluminescent display, or other flat display.

A touch panel for performing various inputs may be integrally formed with the surface of the display 23. In this case, the touch panel functions as the operation unit 22.

In the embodiment, the nail design that was input or selected from the operation unit 22 or the like by the user, various guidance screens, warning display screens, and the like can be displayed on the display 23. The contents displayed on the display 23 are not limited to these.

The configuration of the housing 2 is not limited to the illustrated example. For example, the location of the operation unit 22 and the display 23 is not limited to on the upper surface (top plate) of the housing 2, but may be on the front surface or the lateral surface of the printing device 1.

A device body that includes the dividing plate 15 dividing the inside of the housing 2 into upper and lower sections and the like is housed inside the housing 2.

A finger placing unit 3 to place a finger U corresponding to a nail T that is the printing target during printing is provided nearly at the center in the left-right direction (X-direction in FIG. 1) of the device in the dividing plate 15.

The space below the dividing plate 15 is a drying space for drying the nails T after printing, where the drying device 6 is disposed.

In the embodiment, an opening 31 of the finger placing unit 3 is formed upper than the dividing plate 15. The finger U is inserted into the finger placing unit 3 through the opening 31, and the nail T is printed by a printing mechanism 4 as described below. After printing, the hands H are inserted into the drying space below the dividing plate 15 so that the nails T can be dried by the drying device 6, as shown in FIG. 1.

FIG. 2 is a main part diagram schematically showing the state in which both hands are set in the drying device in the embodiment.

As shown in FIGS. 1 and 2, in the embodiment, the drying device 6 at least includes fans 61 and placing stands 62.

Each of the fans 61 is, for example, an axial fan with propellers (blades) driven to rotate by a motor (not shown in the figure) at approximately the center of a frame 611. The drying device 6 draws in wind (air) from a first surface 611a of the frame 611 and expels wind (air) from the opposite side by rotating the fan 61.

In the embodiment, as shown in FIG. 1, the first surface 611a of the frame 611 is attached to the lower surface of the dividing plate 15. The fan 61 expels a straight-line wind (vertical wind) to below from above. The fan 61 need only generate vertical wind downward, and its specific configuration is not particularly limited.

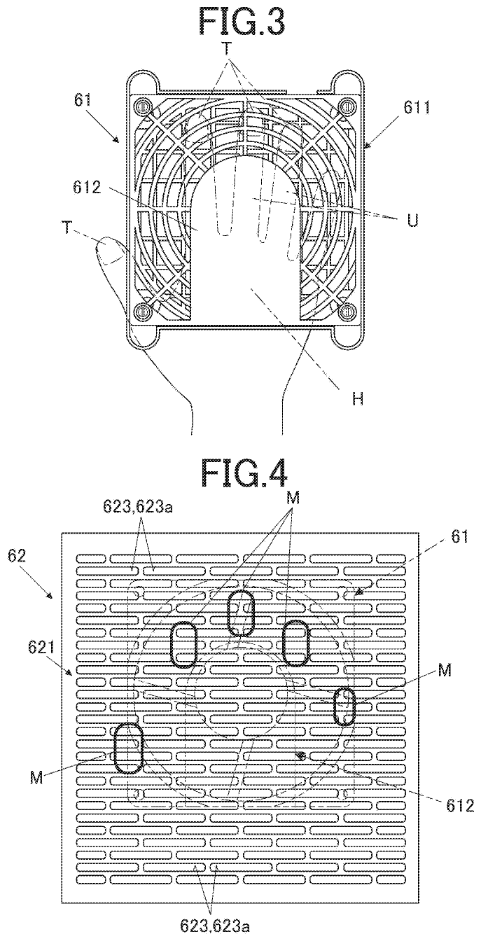

FIG. 3 is a plan view of the fan from the side from which the wind is expelled (opposite side of the first surface). As for the corresponding position of the hand H placed in the drying device 6, FIG. 3 shows the portion that is hidden below the fan 61 and actually invisible, with virtual lines (double-dashed lines).

As shown in FIG. 3, the fan 61 in the embodiment has a covering 612 that covers at least a part of the portion other than the portions corresponding to the nails T that are the drying targets.

The covering 612 is provided on the frame 611, for example, and covers a portion including the center of wind blowing of the fan 61.

Due to the characteristics of the fan 61, the wind volume expelled is low at the center of the wind blowing. The covering 612 narrows the opening range through which wind is blown from the fan 61 by covering the portion including this low wind volume portion. By narrowing the opening range of the fan 61 with the covering 612, the wind speed, and the like can be made stronger (faster) even though the total amount of wind volume expelled is the same.

In the embodiment, the covering 612 covers the portion of the fan 61 corresponding to at least a part of the portion other than the nails T in the hand H or the fingers U corresponding to the nails T. More specifically, as shown in FIG. 3, the covering 612 is provided from the position corresponding to the central portion of the hand H to the position corresponding to the base side of the hand H leading to the arm (not shown in the figure).

When the wind from the fan 61 directly blows to the hand H or fingers U, some users may feel cold, uncomfortable, or other discomfort. In this regard, by blocking at least a part of the portion corresponding to the portion other than the nails T by the covering 612, the wind can be prevented as much as possible from blowing to the portion other than the nails T that are the drying targets.

The position, shape and the like of the covering 612 are not limited to the illustrated example. It is also not essential to provide the covering 612.

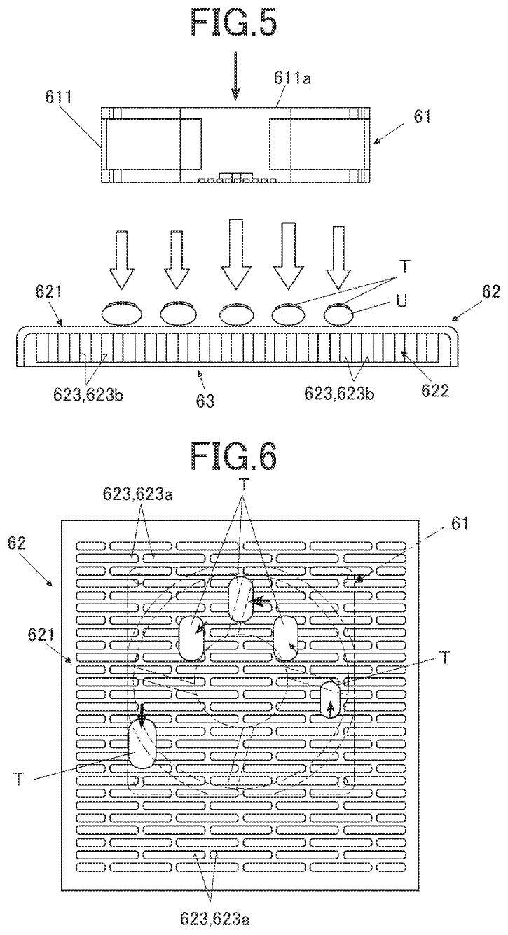

FIG. 4 is a plan view showing the placing stand in the embodiment. FIG. 5 is a schematic side view of the drying device in the embodiment. FIG. 6 is a schematic plan view showing the state in which the nails are placed on the placing stand of the drying device in the embodiment. FIGS. 4 and 6 indicate the corresponding position of the fan 61 in the drying device 6 with the virtual lines (double-dashed lines).

The placing stand 62 is configured to place the nails T (hand H or its fingers U corresponding to the nails T) that are the drying targets. As shown in FIGS. 1, 2 and 5, the placing stand 62 is disposed below the fan 61. The placing stand 62 is formed of a resin, for example. The material of the placing stand 62 is not limited to the resin, but can be widely applied as long as it can provide some strength and durability to the placing stand 62.

The placing stand 62 in the embodiment includes a placing surface 621 on which the hand H (fingers U) including the nails T is placed, and a lateral portion 622 hanging downward from the outer edge of the placing surface 621. The placing surface 621 is located at a higher position than that of the bottom of the printing device 1.

The placing surface 621 and the lateral portion 622 have slits 623 to allow the wind from the fan 61 to pass through. In FIGS. 2, 4 and 6, the slits 623 formed in the placing surface 621 are indicated as slits 623a, and the slits 623 formed in the lateral portion 622 are indicated as slits 623b. When the slits are simply referred to as the slits 623, both the slits 623a and 623b are included.

Each of the slits 623 serves as a ventilation hole that allows the wind from the fan 61 to escape, and its specific shape and the like are not particularly limited as long as it has a structure that allows the wind to pass through easily. For example, the slit 623 may be a coarser grid than shown in the figure.

In addition, as mentioned above, in the placing stand 62 in the embodiment, the placing surface 621 is located at the higher position than that of the bottom of the printing device 1. Thus, a space is formed below the placing surface 621 of the placing stand 62.

This space functions as an exhaust space 63 to which the wind that passed through the slits 623 (for example, slits 623a in the placing surface 621) escapes.

The space that functions as the exhaust space 63 is formed by having the placing surface 621 of the placing stand 62 higher than the setting surface (floor surface, and the like) by the height of the lateral portion 622. In the embodiment, the lateral portion 622 functions as a raiser that raises the placing surface 621.

By providing the exhaust space 63, it is possible to efficiently discharge the wind that passed through the slits 623, without convection. Since the slits 623b are also provided in the lateral portion 622 in the embodiment, the wind discharged to the exhaust space 63 is further discharged outside through the slits 623b.

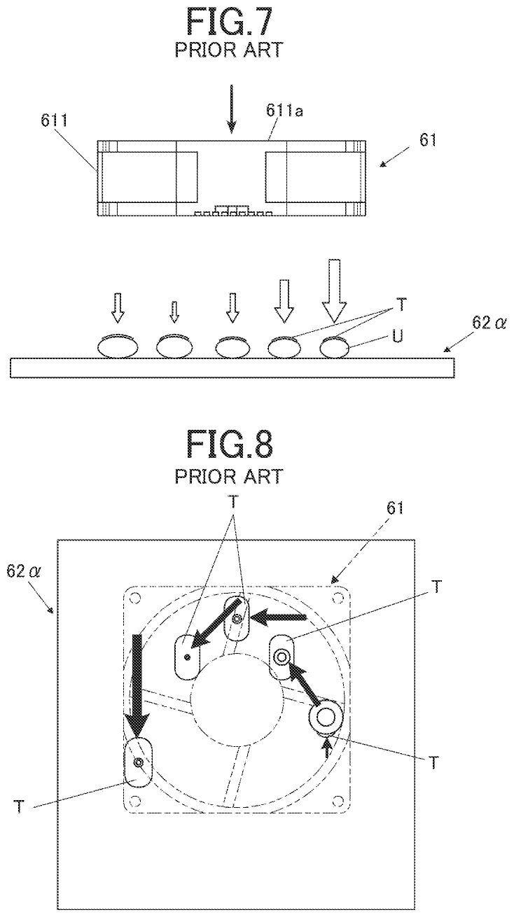

In contrast, FIG. 7 is a schematic side view of a conventional drying device, and FIG. 8 is a schematic plan view showing the state in which the nails are placed on the placing stand of the conventional drying device. In FIG. 8, the corresponding position of the fan 61 is indicated by the virtual lines (double-dashed lines).

The placing stand 62a of the drying device 6 shown in FIGS. 7 and 8 is a plate or the like on which the hand H or its fingers U corresponding to the nails T is placed, and does not have the slits 623. The configuration and the like of the fan 61 are similar to those of the fan 61 in the embodiment shown in FIG. 2. In FIGS. 5 through 8, the white arrows mean vertical winds, and the black arrows mean non-vertical (for example, horizontal) winds. The thickness and length of each arrow signifies the strength of the wind. The longer and thicker the arrow is, the stronger the wind is (that is, the wind speed is faster, the wind volume is higher, and the like).

In the configuration of the embodiment, as shown in FIG. 5, the vertical wind from the fan 61 blows to the surface of the nail T for each finger U of the hand H placed on the placing surface 621 of the placing stand 62 almost uniformly. FIG. 6 shows that there is very little, if any, wind (for example, crosswind) in non-vertical directions among winds that blow to the surfaces of the nails T.

In FIG. 5, there is some variation in the arrows indicating the wind force. This is due to the fact that, as a characteristic of the fan 61, the wind strength varies somewhat depending on the position where the nail T is placed.

In contrast, when the nails T are placed on the placing stand 62a that does not include the slits as shown in FIGS. 7 and 8, as shown in FIG. 8, winds in non-vertical directions (for example, crosswinds) among winds that blow to the surface of the nails T are much stronger, while vertical winds are weaker, and the variation in the vertical wind strength depending on the position where the nail T is placed is also greater.

This is considered to be due to the fact that vertical wind by the fan 61 from above to below bounces back when it blows to the placing stand 62a, and convects and rotates on the placing surface of the placing stand 62a, generating crosswinds and the like. As shown in FIG. 8, this creates a horizontally rotating wind flow on the placing surface of the placing stand 62a, which cancels out the vertical wind.

When drying the nails T on the placing stand 62, vertical wind from above to below is more efficient in drying than horizontal wind and the like.

In addition, if the wind blows as uniformly as possible to all the nails T on the placing stand 62, the drying speed will not vary, and multiple nails T can be dried efficiently in a relatively uniform amount of time.

In this regard, by providing the slits 623 in the placing stand 62 as in the embodiment, as shown in FIG. 5, the vertical wind from the fan 61 can blow almost uniformly to each nail T and perform the drying process more efficiently than in a configuration as in FIG. 7 that has no wind escape path.

As shown in FIG. 4, it is preferable that the placing stand 62 is provided with a placement indicators M that indicate the approximate positions where the nails T are to be placed. The placement indicators M are arranged corresponding to the respective five nails T of one hand, on each of the placing stands 62. Since the fan 61 has somewhat different wind speeds and the like depending on the position, it is preferable that the placement indicators M are arranged according to such wind speed distribution of the fan 61. This allows the fan 61 to blow the wind of equal strength uniformly to all the nails T placed on the placing stand 62, resulting in efficient, variation-free drying and high-quality nail finishing.

The specific form of the placement indicator M is not particularly limited. FIG. 4 shows an example in which a nail-shaped mark (placement indicator M) is provided by printing or other means at the position where each nail is to be placed. Other than the illustrated example, it is conceivable, for example, to provide unevenness at the location where the nail T is to be placed, as the placement indicator M.

The position corresponding to the fan 61, the position corresponding to the covering 612 of the fan 61, and the like may also be indicated by printing, or the like on the placing surface 621, or the like (that is, for example, the lines shown as virtual lines (double-dashed lines) in FIGS. 4 and 6 are actually printed on the placing surface 621).

As mentioned above, in the embodiment, the covering 612 is provided to cover the portion of the fan 61 corresponding to at least a part of the portion other than the nails T in the hand H or the fingers U corresponding to the nails T. However, this covering 612 is difficult to see its location without looking up at the fan 61 from below, as shown in FIG. 3.

In this regard, by providing a mark or the like (placement indicator M) that serves as a guide when placing the nail T on the placing surface 621 or the like where the hand H or the fingers U are placed, it becomes easier for the user to place the nail T in an appropriate position, avoiding the portion corresponding to the covering 612.

The drying device 6 is not limited to those that include the fans 61 shown in the embodiment as long as it can dry the nail(s) T of the finger(s) U of the hand(s) H placed in the drying device 6. The drying device 6 can be of any other configuration as long as it is capable of creating a vertical wind flow from above to below by blowing wind.

Depending on the type of ink and the like, the drying speed may be increased by heating or cooling. In such cases, the drying device 6 may include, for example, a heat generator (heater) and/or a cooling device as appropriate, in addition to the fans 61.

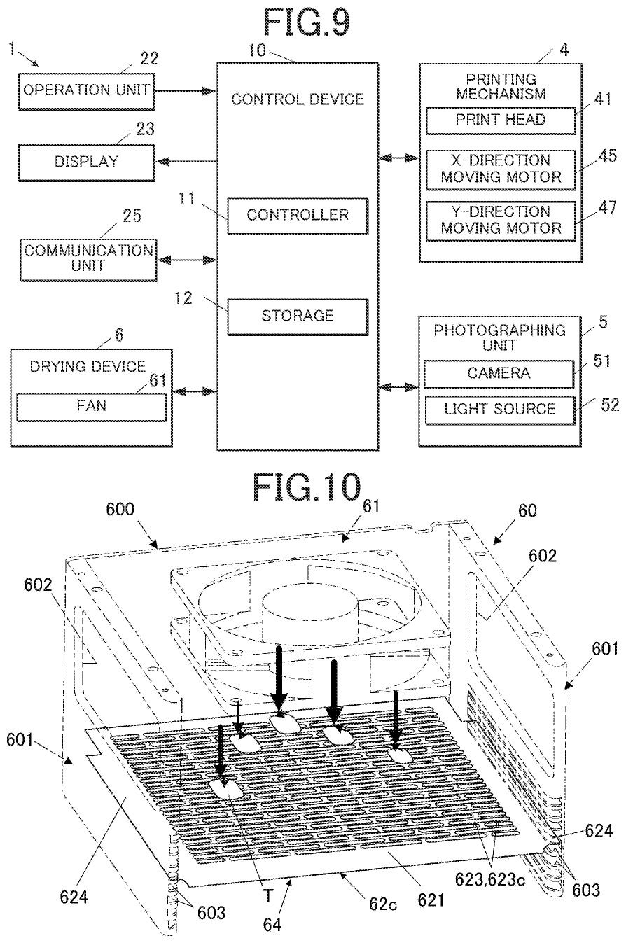

FIG. 9 is a main part block diagram showing the control configuration of the printing device according to the embodiment.

The printing mechanism 4, and the photographing unit 5, and the like shown in FIG. 9 are provided in the space upper than the dividing plate 15.

The printing mechanism 4 performs printing on the surface (printing target surface) of the nail T that is the printing target.

The printing mechanism 4 includes a print head 41, a moving mechanism that moves the print head 41 as appropriate, and the like.

The print head 41 in the embodiment includes an ink ejection unit (not shown in the figure) in which an ejection port to eject ink is formed on the lower surface (surface facing the surface of the dividing plate 15). The print head 41 is a cartridge-integrated head that has a pooling unit (ink cartridge) to pool the ink integrated with the ink ejection unit.

The print head 41 is an inkjet head that performs printing by spraying micro droplets of ink from the ink ejection unit onto the printing target surface.

The print head 41 is able to eject ink of colors (hereinafter, referred to as “color inks”) such as cyan (C), magenta (M) and yellow (Y), for example. The type of the print head 41 included in the printing device 1 is not limited to this. For example, a head for base that prints a liquid agent as a base before printing a design may be provided.

The type and the number of the print head 41 are not limited to the example shown in the embodiment. In addition, the print head is not limited to the print head that performs printing by the inkjet method, but may include print heads that perform printing (applying a liquid agent such as ink) by various methods.

The moving mechanism moves the print head 41 (holder that holds the print head 41 in the case where the print head 41 is held in the holder) in the X direction that is the left-right direction of the device and in the Y direction that is the front-rear direction of the device (see the X direction and the Y direction in FIG. 1).

The moving mechanism includes an X-direction moving motor 45 that drives during the movement in the X direction and the Y-direction moving motor 47 that drives during the movement in the Y direction. The X-direction moving motor 45 and the Y-direction moving motor 47 are stepping motors, for example.

The photographing unit 5 includes a camera 51 and a light source 52.

The photographing unit 5 is attached to the inner side of the top surface of the housing 2 or the supporting member (not shown in the figure) vertically provided on the dividing plate 15, for example. The location of the photographing unit 5 is not particularly limited, but the photographing unit 5 is located nearly in the central portion (above the finger placing unit 3 or its nearby position) in the left-right direction of the device (X direction), for example.

The configuration and the location of the photographing unit 5 are not limited to the illustrated example.

The camera 51 is, for example, a small-sized camera configured by including a CCD (Charge Coupled Device) type or CMOS (Complementary Metal Oxide Semiconductor) type solid imaging element which has approximately two million pixels or more and a lens. The light source 52 is configured by an LED, for example.

In the embodiment, the image (referred to as “nail image”) of the finger U including the nail T is obtained by photographing, with the camera 51 of the photographing unit 5, the finger U and its nail T placed in the finger placing unit 3 while illuminating them with the light source 52 as appropriate. Then, as described below, the shape of the nail T that is the printing target (“nail outline”) is detected (obtained) from this “nail image”.

The control device 10 mounted on the printing device 1 is a computer that includes: a controller 11 (see FIG. 9) configured by including a processor such as a CPU (Central Processing Unit) not shown in the figure; and a storage 12 (see FIG. 9) configured by including a ROM (Read Only Memory), a RAM (Random Access Memory) not shown in the figure, and the like.

The control device 10 is mounted on the substrate (not shown in the figure) disposed on the inner side (lower surface side) of the upper surface (top plate) of the housing 2, for example.

The storage 12 stores various types of programs for operating the printing device 1, data, and the like.

Specifically, the storage 12 stores various programs such as a printing control program for performing the printing process, and a drying control program for performing the drying process of the nails. The components of the printing device 1 are integrally controlled by the controller 11 loading these programs to the working area of the RAM and executing the programs, for example.

The storage 12 also stores various types of data regarding the nail outline and the nail shape obtained by the controller 11, and the like.

The storage 12 may store data such as the nail image obtained by the photographing unit 5 and may store other various types of data.

From a functional point of view, the controller 11 performs control of the display 23, control of the photographing unit 5, control of the nail information detector, printing data generator and printing mechanism 4, and control of the drying device 6, for example. The controller 11 also detects the nail information as described below and generates printing data. The function of the controller 11 is not limited to the functions shown in the embodiment as an example. For example, the printing device 1 includes a communication unit 25 for performing communication with external devices such as various terminal devices, and the controller 11 can control the operation of this communication unit 25 to communicate with the external devices.

Each function of the controller 11 is realized by the cooperation between the controller 11 and the program stored in the storage 12.

That is, the controller 11 controls the display operation of the display 23.

In accordance with display instruction signals from the controller 11, various types of displaying are performed on the display screen of the display 23.

The controller 11 controls the camera 51 and the light source 52 of the photographing unit 5 to perform photographing and obtains the image.

In the embodiment, the controller 11 controls the photographing unit 5 (camera 51 and light source 52 of the photographing unit 5) to photograph the nail T (finger U including the nail T) placed in the finger placing unit 3, and obtains the nail image.

Furthermore, the controller 11 obtains information (referred to as “nail information”) regarding the nail T by analyzing (image analysis, image processing) the nail image obtained by causing the photographing unit 5 to perform photographing.

Specifically, the controller 11 detects the nail information regarding the nail T of the finger U on the basis of the nail image obtained by the camera 51 of the photographing unit 5.

The nail information obtained by the controller 11 is, for example, the nail outline that demarcates the region of the nail T by separating the nail T from the other portion (skin portion of the finger, and the like).

The nail information detected by the controller 11 is not limited to the nail outline. For example, the nail information may include the inclination angle (inclination angle of the nail, nail curvature) of the surface of the nail T with respect to the XY plane. In the case where the height of the nail T (position in the vertical direction of the nail T) can be obtained from the nail image and the like photographed by the camera 51, the height of the nail T may also be included in the nail information.

In addition, the controller 11 generates printing data by fitting the desired design to the nail outline (nail region that is the region inside the nail outline) as the detected nail information.

Specifically, the controller 11 cuts out image data of the design (nail design) selected by the user, and performs enlargement and reduction, and adjustment of location as appropriate, and performs fitting into the nail outline detected from the image of the nail T.

In the case where the controller 11 obtains the curvature or the like of the nail T, the controller may perform curved surface correction to the printing data as appropriate, on the basis of this nail curvature or the like. In the case where the curved surface is corrected, it is possible to generate printing data that is more suited to the shape of the nail T.

The controller 11 also controls the components of the printing mechanism 4 so as to perform printing on the nail T in accordance with the generated printing data.

Specifically, the controller 11 outputs control signals to the printing mechanism 4 on the basis of the printing data, and controls the X-direction moving motor 45, the Y-direction moving motor 47, the print head 41, and the like of the printing mechanism 4 so as to perform printing in accordance with the printing data on the nail T.

The controller 11 controls the operation of the drying device 6.

Specifically, the controller 11 controls the operation of the fan 61 of the drying device 6 to generate the vertical wind from above to below. In the case where the drying device 6 includes a heat generator (heater), a cooling device, and the like, in addition to an wind blower such as the fan 61, the controller 11 also controls them as appropriate.

Next, the action and the effect of the drying device 6 and the printing device 1 including the drying device 6 in the embodiment will be described.

In the embodiment, when the operation unit 22 (operation button) or the like of the printing device 1 is operated to turn on and activate the printing device 1, the design to be printed on the nail T and the finger U corresponding to the nail T to be printed are selected/set from the selection screen or the like (not shown in the figure) of the display 23, and the nail region that is the printing region is recognized from the nail image obtained by the photographing unit 5. Then, the desired design is printed on the recognized nail region by the printing mechanism.

When the printing has been completed, the nails T after printing are placed in the drying device 6 and the nails T to which the ink or the like is applied are dried. In the embodiment, FIGS. 1 and 2 illustrate a case where both hands are placed together in the drying device 6. However, the number of the nails T to be placed in the drying device 6 is not particularly limited. For example, one hand at a time may be placed in the drying device 6 to dry the nails T, or one finger U at a time may be placed in the drying unit 6 to perform the drying process of the nail T.

Specifically, the user places the fingers U corresponding to the nails T to be dried on the placing surface 621 of the placing stand 62. At this time, the user places the nails T according to the respective placement indicators M. The user then switches on the fan 61 in the state in which the nails T are placed at the appropriate positions. The drying device 6 is switched on/off by the operation control performed by the controller 11 of the printing device 1. The switching on/off of the drying device 6 is not limited to this. Mechanical switches that allow the user to manually switch on/off the drying device 6 may be provided.

When the drying device 6 is switched on, the fans 61 rotate, expelling the wind from above to below. The expelled wind blows to the surfaces of the nails T on the placing stand 62. The wind that does not blow to the nails T but is directed directly to the placing stand 62 escapes through the slits 623 in the placing surface 621, and the like, to the back side of the placing surface 621. The wind that escapes from the slits 623 to the back side of the placing surface 621 flows into the exhaust space 63 and is quickly discharged to the outside through the slits 623b in the lateral portion 622, and the like.

When the wind from the fan 61 convects and forms a whirlpool on the placing stand 62, much of the vertical wind is changed into the non-vertical crosswind, or the like. If the wind blowing to the nail T is the crosswind, or the like, it cannot dry the nails effectively compared to the vertical wind. Furthermore, if ink that has not dried is exposed to the crosswind, and the like, the ink will run with the wind before it is fixed in its original position, causing blurs, uneven colors, and the like.

In the embodiment, the wind from the fan 61 escapes to the exhaust space 63 through the slits 623 before it changes to the crosswind and the like on the placing surface 621, so that most of the wind blowing on the nails T becomes vertical wind, effectively drying the surfaces of the nails T.

As described above, the drying device 6 in the embodiment includes fans 61, placing stands 62, and exhaust spaces 63. Each of the fans 61 includes a covering 612, which covers at least a part of the portion other than the portions corresponding to the nails T that are the drying targets, and blows wind from the upper direction toward the surfaces of the nails T. Each of the placing stands 62 is disposed below the fan 61 and includes the slits 623 that allow the wind from the fan 61 to pass through, and the nails T are placed on the placing stand 62. Each of the exhaust spaces 63 is formed below the placing stand 62, and the wind that has passed through the slits 623 escapes to the exhaust space 63.

By providing the covering 612 that covers a portion of the fan 61 in such a way, it is possible to narrow the opening range of the fan 61 to increase the strength of the wind from the unblocked portion.

This allows strong wind from the fan 61 to blow to the surface of the nail T. It is also possible to create a flow of wind directing the wind from the fan 61 vertically from above to below and suppress the generation of wind in non-vertical directions (crosswinds and the like), so that more vertical wind blows to the nails T placed on the placing stand 62.

This allows the surface of the nail T to be dried effectively and efficiently, and also prevents the ink from running before drying and causing blurs, uneven colors, and the like due to the influence of crosswinds, and the like.

In addition, even when nails T of multiple fingers U such as the nails T of both hands are placed, the wind can uniformly blow to all the nails T. This reduces the variation in finish for each nail T and allows drying of all the nails T to the same quality and in a shorter time.

The covering 612 in the embodiment covers a portion including the center of wind blowing of the fan 61.

The center of wind blowing of the fan 61 is the portion where relatively little volume of wind can be expelled. By blocking such a portion where no wind volume is expected, the opening range can be narrowed down and the strength of the wind from the unblocked portion can be strengthened.

The covering 612 in the embodiment covers the portion of the fan 61 corresponding to at least a part of the portion other than the nails T in the hand or the fingers corresponding to the nails T.

Thus, the opening range can be narrowed down and the strength of the wind from the unblocked portion can be strengthened.

It also reduces the wind that blows to the portion other than the nails T (for example, the back of the hand H or the fingers U), preventing the user of the drying device from feeling cold, uncomfortable, or other discomfort.

The placement indicators M indicating approximate positions where the nails T are to be placed are provided on the placing stand 62 in the embodiment.

This allows the user to avoid getting lost in the positions where the nails T are to be placed, and to dry the nails T in the location where they can be properly dried.

The printing device 1 in the embodiment includes the drying device 6 as described above together with the printing mechanism 4 that performs printing on the nail T of each finger U.

Thus, after the printing by the printing mechanism 4, the nails T to which the ink or the like has been applied can be effectively dried by simply placing the hands H and the fingers U including the nails T after printing on the placing stands 62 in the drying device 6 and turning on the drying device 6.

Therefore, the process from printing to finishing of the nail design can be easily completed with a single device.

Though the embodiment of the present disclosure has been described above, the present disclosure is not limited to such an embodiment, and various modifications can be made within the scope of the present disclosure.

For example, the embodiment takes, as an example, a case where the drying device 6 includes a pair of left and right fans 61 and a pair of left and right placing stands 62 corresponding to the drying of nails T of the left and right hands H, as shown in FIGS. 1 and 2. However, the drying device 6 may include a single fan 61 and a single placing stand 62. In this case, the user places one hand H at a time in the drying device 6 to dry the nails T for one hand at a time.

In the case where the drying device 6 includes only a single fan 61 and a single placing stand 62, compared to the configuration in which both hands are placed inside the device, a compact device configuration can be achieved in the width direction (X-direction). Since the configuration of the fan 61 and the placing stand 62 is almost symmetrical, the nails T of either of the left and right hands H can be treated with the single fan 61 and the single placing stand 62.

In addition, even in the case where two left and right fans 61 are provided as the configuration of placing the left and right hands in the device, the placing stand 62 may be a wide, single-connected stand in the width direction of the device (X direction in FIG. 1).

Though the embodiment takes, as an example, a case where the printing device 1 includes the drying device 6, the drying device 6 is not limited to the device integrated with the printing device 1. The drying device 6 may be configured as a drying device alone.

FIG. 10 shows an example of the case where the drying device is configured as a stand-alone device.

In the example shown in FIG. 10, the drying device 60 includes a nearly box-shaped housing 600 as a case to house the device body. The fan 61 and a placing stand 62c are placed in this housing 600. In FIG. 10, the housing 600 is shown with the double-dashed lines and the inside of the housing 600 is shown transparently in order to make the internal configuration easier to see.

In the example shown in FIG. 10, the first surface side of the fan 61 is attached to the inner side or the like of the top surface of the housing 600. Since the specific configuration of the fan is the same as that shown in the aforementioned embodiment, the same codes are used for similar parts and their descriptions are omitted.

The placing stand 62c is disposed below the fan 61, and the nails T that are the drying targets (hand H or its fingers U corresponding to the nails T) are placed on the placing surface 621 that is the surface facing the fan 61.

The slits 623 (slits 623c) that serve as ventilation holes that allow the wind from the fan 61 to escape are formed in the placing surface 621. Similarly to the slits 623 (slits 623a) shown in FIG. 4, the shape and the like of the slits 623 are not particularly limited.

Though not shown in the figure, it is preferable that placement indicators are provided by printing or the like on the placing surface 621.

In the example shown in FIG. 10, the placing stand 62c is formed in a plate shape. There are locking plates 624 on both sides (both sides in the width direction of the device, both sides in the X direction in FIG. 10) of the portion as the placing surface 621 where the nails T and the like are placed. On the walls 601 on both sides in the width direction of the device in the housing 600, guide grooves 603 to which the locking plates 624 can be fitted by sliding are formed at multiple different heights from the front side of the device to the depth direction.

Since the size and thickness of the hand H varies from user to user, the distance between the hand H (nails T of the fingers U of the hand H) placed on the placing surface 621 and the fan 61 is different for people with thicker and thinner hands H. If the distance from the fan 61 is too far away, sufficient wind cannot be received, and efficient drying will not be possible. On the other hand, if the fan 61 is too close, too strong wind may cause the ink to run or blur before drying. Furthermore, it can cause failures such as ink peeling off when the nail T accidentally touches the fan 61 and the like while moving the hand H in and out of the device.

In this regard, by providing the locking plates 624 to the placing stand 62c and providing the guide grooves 603 at different multiple heights to the walls 601 so as to enable locking the locking plates 624 to the guide grooves 603 at the desired height, the user can dry the nails T at the height position suitable for his/her hand H.

The guide grooves 603 are configured to hold the locking plates 624 and the placing stand 62c at the position higher than the floor surface (setting surface) on which the device is set even when the guide grooves 603 are located at the lowest position. This allows the exhaust space 64 to be secured below the placing stand 62c, regardless of which height guide grooves 603 are used to lock the locking plates 624.

In the case of the drying device 60 configured in such a way, the walls 601 on both sides of the housing 600 holding the locking plates 624 and the placing stand 62c function as a raiser that raises the locking plates 624 and the placing stand 62c to create the space that functions as the exhaust space 64 below the placing stand 62c.

In the case of configuring the drying device 60 as a stand-alone device, it is not essential to hold the placing stand 62c in the housing 600 by locking the locking plates 624 to the guide grooves 603. Instead of such a configuration, as shown in FIGS. 1 and 2 as mentioned above, the exhaust space 63 may be secured below the placing surface 621 by providing the lateral portion 622 hanging down from the outer edge of the placing surface 621.

Conversely, in the case where the drying device 6 is incorporated into the printing device 1, the configuration capable of adjusting the height of the placing surface may be adopted.

As shown in FIG. 10, a vent 602 that allows the wind generated by the fan 61 to pass through may be provided to at least a part of each of the walls 601 that are the perimeter wall surfaces of the housing 600.

By providing not only the slits 623 in the placing stand 62c, but also wind path (escape path) in the housing 600, the wind flow from the fan 61 can be made smoother, which is expected to further reduce the occurrence of convection and whirlpool of wind inside the device.

This eliminates wind from non-vertical directions as much as possible from the wind blowing to the nails T. This allows the strong vertical wind from the fan 61 to blow to the surfaces of the nails T more effectively and dry the nails T more efficiently.

The position, size, shape and the like of the vent 602 are not particularly limited as long as the wind can pass through the vent 602. Though FIG. 10 illustrates providing the vents 602 in the walls 601 on both sides of the housing 600, the vent 602 may be provided in the wall 601 on the back surface side of the housing 600, for example.

Furthermore, proving the vent 602 that allows the wind generated by the fan 61 to pass through in the housing is not limited to the case of configuring the drying device 60 as a stand-alone device. Even in the case where the drying device 6 is incorporated into the printing device 1 as shown in FIG. 1, there may be a configuration allowing the wind generated by the fan 61 to escape from the hosing 2, by providing slits or vents to a part of the housing 2 in the portion below the dividing plate 15 where the drying device 6 is disposed, for example.

The embodiment takes, as an example, the printing device 1 configured to be able to complete the printing process and drying process alone. However, the printing device 1 is not limited to the printing device shown in the embodiment. For example, the printing device 1 may be the device that performs the printing process and the like in cooperation with various external devices including terminal devices such as smartphones, for example.

In the case where the printing device 1 performs various processes in cooperation with an external device, for example, the detecting process of nail information from the nail image and the generation process of the printing data may be performed in the external device (for example, a terminal device such as a smartphone).

In this case, when the nail T is photographed with the camera 51 of the photographing unit 5 to obtain the nail image (image of the nail T including the finger U), the nail image obtained by the photographing unit 5 is transmitted to the external device via the communication unit 25. The control device of the external device may detect the nail information and generate the printing data, and the generated printing data may be transmitted to the printing device 1.

In this case, the printing device 1 may include only the printing mechanism 4, the photographing unit 5, and the drying device 6, resulting in the simplified configuration of the printing device 1.

Furthermore, the embodiment takes, as an example, a case where the operation unit 22 and the display 23 are provided in the printing device 1. However, in the case where the printing device 1 performs various processes in cooperation with the external device, the operation unit and the display of the external device may perform various input operations and display various screens in place of them, in which case the printing device 1 does not need to include the operation unit 22 or the display 23.

The method for obtaining the design (nail design) to be printed on the nail T is not particularly limited.

For example, data stored in the external device may be obtained via the communication unit 25 by the printing device 1.

It is also possible to store image data of nail designs in a server device or the like that can be connected via a network line or the like, so that the nail design data can be referenced by accessing the server device or the like.

In this way, the variation of printable nail designs can be increased without increasing the capacity of the storage 12 or the like.

In the embodiment, the inkjet-type print head 41 is provided as the print head 41 of the printing device 1. However, the configuration of the print head 41 is not limited to this.

The configuration different from the inkjet-type print head 41 such as a syringe-type head and a pen-type head may be provided.

Though several embodiments of the present disclosure have been described above, the scope of the present disclosure is not limited to the above embodiments, and includes the scope of inventions, which is described in the scope of claims, and the scope equivalent thereof.

1. A drying device comprising:
a fan which blows a wind from an upper direction toward a surface of a nail that is a drying target;
a placing stand which is disposed below the fan and includes a slit that allows the wind from the fan to pass through, and on which the nail is placed; and
a raiser that is formed below the placing stand and includes an exhaust space to which the wind passing through the slit escapes.

2. The drying device according to claim 1, wherein the fan includes a covering which covers at least a part of a portion other than a portion corresponding to the nail that is the drying target.

3. The drying device according to claim 2, wherein the covering covers a portion including a center of wind blowing of the fan.

4. The drying device according to claim 2, wherein the covering covers a portion of the fan corresponding to at least a part of a portion other than the nail in a hand corresponding to the nail.

5. The drying device according to claim 3, wherein the covering covers a portion of the fan corresponding to at least a part of a portion other than the nail in a hand corresponding to the nail.

6. The drying device according to claim 1, wherein a placement indicator indicating an approximate position where the nail is to be placed is provided on the placing stand.

7. The drying device according to claim 2, wherein a placement indicator indicating an approximate position where the nail is to be placed is provided on the placing stand.

8. The drying device according to claim 3, wherein a placement indicator indicating an approximate position where the nail is to be placed is provided on the placing stand.

9. The drying device according to claim 4, wherein a placement indicator indicating an approximate position where the nail is to be placed is provided on the placing stand.

10. The drying device according to claim 1, further comprising a housing in which a device body is housed, wherein
a vent which allows the wind generated by the fan to pass through is provided in at least a part of a perimeter wall surface of the housing.
